(19) United States
(12) Patent Application Publication
(10) Pub. No.: US 2019/0022536 A1
(43) Pub. Date: Jan. 24, 2019

(54) Methods of Parent/Guardian Notification in Electronic Game Playing

(71) Applicants: Guo Song Hu, Toronto (CA); William Zhijing Hu, Toronto (CA)

(72) Inventors: Guo Song Hu, Toronto (CA); William Zhijing Hu, Toronto (CA)

(21) Appl. No.: 15/655,944

(22) Filed: Jul. 21, 2017

(51) Int. Cl. A63F 13/85; A63F 13/73; A63F 13/332; G08B 25/10; G08B 21/18

(52) U.S. Cl. CPC A63F 13/85; A63F 13/73; H04W 4/14; G08B 25/10; G08B 21/18; A63F 13/332

(57) ABSTRACT

Methods of notifying parent/guardian when a child starts to play electronic games and a method of notifying parent/guardian when a child tries to order an equipment/artifact with payment in electronic games are disclosed. The methods include registering a game account with parent/guardian notification ability in an online web site or a PC/Mobile/Tablet App game in electronic games by collecting parent/guardian's notification preference information and saving the information in a database, or file system, or other data-storage mediums, sending notification to parent/guardian by SMS/MIM/Email/Phone or any other communication protocols or methods. The methods also include that the parent/guardian can approve or reject the playing request in the response, and the game system will approve or reject the player's playing request based on the parent/guardian's response.

### CROSS-REFERENCE TO RELATED APPLICATIONS

None.

### BACKGROUND OF THE INVENTION

In current digital times, almost all kids play more or less electric games. Many scientific researches indicate that playing electric games are good for developing visual abilities, motor skills and brain growth. But the researches also indicate that over playing electric games increases the possibility of addiction and violence. Also most of parents want their kids to study instead of playing games at the mean time. So playing electric game in a controlled way is good instead of bad. Over playing is bad. The key is control the time. But as we all know sometimes even adults are very hard to control themselves in game playing because many electric games such as “World of Warcraft” and “Legend of League” are so attractive. So we need parent/guardian to help the kids to control the time spent on electric game playing.

Also over spending money in game playing has caused a lot of social problems. In China, a 10-years old boy spent about US $15,000 to buy equipment within 1 month when playing “King Glory” by Tencent because in China, which caused financial problems of their family business.

The purposes of the invention are that parent/guardian is notified when kids start to play game and try to buy equipment. Also the authorization processes will force the kids to communicate with their parent/guardian and eventually improve their negotiation skills in order to get playing time and buying the equipment they want.

### BRIEF SUMMARY OF THE INVENTION

This invention relates to methods to notify the parent/guardian when kids start to playing game. Specifically, this invention relates to: (1) parent/guardian is notified when kids login to their gaming account; (2) parent/guardian is notified when kids order equipment/artifacts with spending real money; (3) parent/guardian can approve or reject the game playing in the response; and (4) The parent/guardian can approve or reject the order of equipment/artifacts in response. The invention is applicable to all electronic games involving a display screen or graphical user interface.

### BRIEF DESCRIPTION OF THE DRAWINGS

A clear understanding of the key features of the invention summarized above may be had by reference to the appended drawings, which illustrate the methods of the invention, although it will be understood that such drawings depict preferred embodiments of the invention and, therefore, are not to be considered as limiting its scope with regard to other embodiments which the invention is capable of contemplating. Accordingly:

FIG. 1 illustrates an example scenario of the method to notify parent/guardian when player tries to play game.

FIG. 2 illustrates an example scenario of the method to notify parent/guardian when player tries to order an equipment/artifact.

FIG. 3 illustrates an example scenario of the method to register a game account with notification ability for online web game.

FIG. 4 illustrates an example scenario of the method register a game account with notification ability for mobile/PC/tablet game App.

### DETAILED DESCRIPTION OF THE PREFERRED EMBODIMENTS

Games: Games referenced in this invention can ice electronic games playing on a PC, a Mac, a laptop, a mobile device such as a smart phone or tablet, a play station, an Xbox, a device, or any other electronic devices displaying games on a screen or a VR glasses in the genres of role paly games, strategy games, action-adventure games, adventure games, and simulation games of both online and offline.

User Interfaces: User interfaces referenced in this invention can be any kinds of user interfaces, such as graphical user interface, VR interface, voice conversation interface, in electronic games. What the invention focuses is that the players earn experience points, get level up, learn skills/abilities, collect resources, and get access to an object or disarm traps, by answering academic questions correctly.

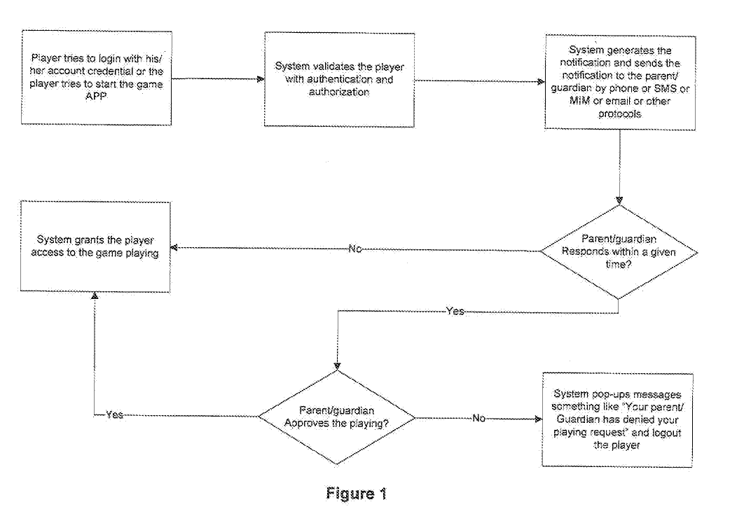

FIG. 1 is demonstrates how the parent/guardian is notified when a player tries to play game. Player tries to login with his/her account credential on an, online web site or the player tries to start the game APP in a PC or tablet or a mobile device. The system validates the player by authentication and authorization. After the player passes the authentication and authorization, the system generates the notification and sends the notification to the parent/guardian by phone/SMS (Short Message Service)/MIM (Mobile Instant Messaging, such as WeChat, What's App)/email or other protocols based on the method preferred by the guardian in the registration. The system will be waiting for a given time (Such as a minute) for the parent/guardian's response. If there is no response in the given time, the system considers the request is approved and the player will be granted with the game playing. If the system received a response from the parent/guardian, the system will judge if it is a approval or a rejection. If it is an approval, the player will be granted with the game playing. If it is a rejection the player will be denied to access the game playing with messages of reason.

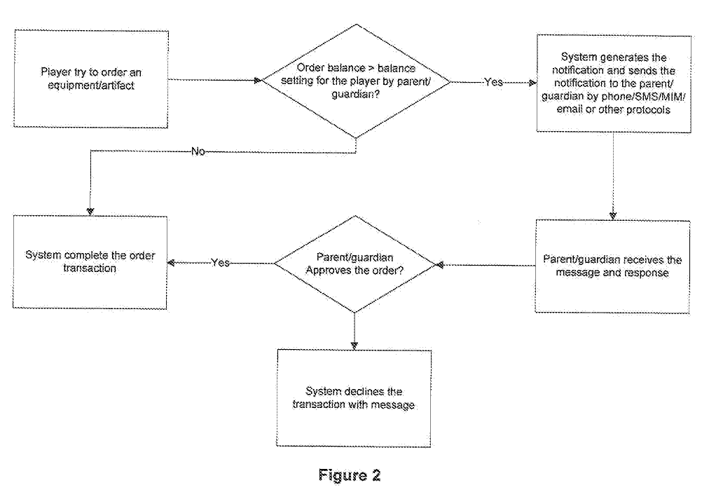

FIG. 2 demonstrates how the parent/guardian is notified when a player tries to order an equipment/artifact. When a player tries to order an equipment/artifact, the system will check if the value of the equipment/artifact is greater than, a given value set by the guardian. If it is less the given value, the system will complete the order transaction. If the value is greater than the given value or the system just determines whatever the values is, the system generates the notification and sends the notification to the parent/guardian by phone/SMS/MIM/email or other protocols based on the method preferred by the guardian in the registration. The parent/guardian can either approve or reject the order request in the response. If it is an approval response, the system will complete the order transaction. On the contrary the system will declines the transaction, and tells the player that her/his parent/guardian does not approve their buying request.

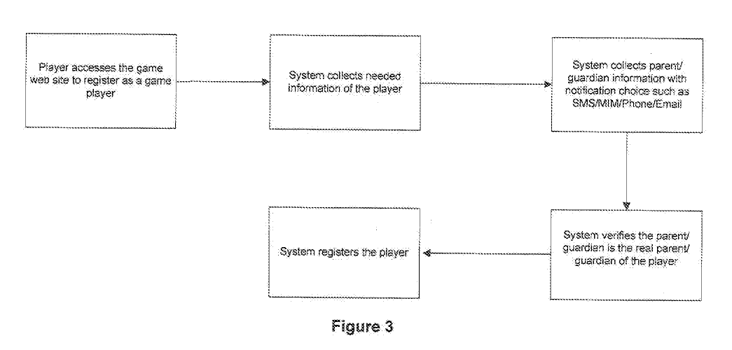

FIG. 3 demonstrates how to register a game player with parent/guardian notification ability in an online web site. When a player accesses the game web site to register as a game player, the system will collect needed information of the player, and also collect parent/guardian information with notification protocol such as SMS/MIM/Phone/Email or other protocols. The system register the player as a user only after the system has verified the parent/guardian is the real parent/guardian of the player.

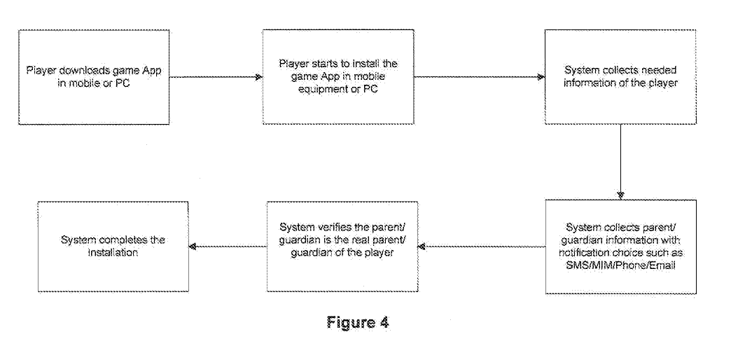

FIG. 4 demonstrates how to register a game player with parent/guardian notification ability in mobile/tablet/PC App games. When a player starts to install the App on the PC or a mobile device, the system will collect needed information of the player, and also collect parent/guardian information with notification protocol such as SMS/MIM/Phone/Email or other protocols. The system register the player as a user only after the system has verified the parent/guardian is the real parent/guardian of the player.

FIG. 7 demonstrates how a game player disarms a trap such as a bomb. For example in a RPC game, a player triggers, a trap of a bomb. The system pop-ups academic question in a given subject (such as English, Mathematics, Science, Physics, Chemistry, Geography, History) with multiple choices or blank fields to be filled. The player answers the question by selecting the answer choices or filling in the blanks. The system validates the answer to validate whether the answers are correct. If the answers are correct, the system disarms the bomb. If the answers are wrong, the system applies some given damages to the player, and disarms the bomb.

The invention has been described in terms of several preferred embodiments above. But it would be understood that various modification may be made. Such as that a notification will not be sent out if the parent/guardian has already setup a player time from 7:00-8:00 pm and the player starts playing the game during the above time.

What is claimed is:

1. The method of Parent/Guardian is notified when a player tries to start playing an electric game.

2. The method of Parent/Guardian is notified when a player tries to order an equipment/artifact in game playing.

3. The method of claims 1 and 2, further including sending the notification to the parent/guardian by SMS.

4. The methods of claims 1 and 2, further including sending the notification to the parent/guardian by MIM such as We Chat, What's App, and Line.

5. The methods of claims 1 and 2, further including sending the notification to the parent/guardian by email.

6. The methods of claims 1 and 2, further including sending the notification to the parent/guardian by Phone.

7. The methods of claims 1 and 2, further including sending the notification to the parent/guardian by any other communication protocols or methods.

8. The methods of claims 1 and 2, further including sending the notification to the parent/guardian by any other protocols or methods.

9. The methods of claims 3 to 8, further including the parent/guardian can response to approve or reject the player's playing request.

10. The methods of claims 3 to 9, further including the game system will approve reject the player's playing request based on the response of the parent/guardian.

11. The methods of claims 3 to 8, further including the parent/guardian can response to approve or reject the player's equipment/artifact order request.

12. The methods of claims 3 to 9 and claim 11, further including the game system will approve or reject the player's equipment/artifact ordering request based on the response of the patent/guardian.

13. The method of registering a game account with parent/guardian notification ability in an online web site in electronic games by collecting parent/guardian's notification preference information and saving the information in a database, or file system, or other data-storage mediums.

14. The method of registering a game account with parent/guardian notification ability in mobile/tablet/PC App games by collecting parent/guardian's notification preference information and saving the information in a database, or file system, or other data-storage mediums.
